(19) United States
(12) Patent Application Publication
(10) Pub. No.: US 2024/0354557 A1
(43) Pub. Date: Oct. 24, 2024

(54) INFORMATION RETRIEVAL USING MULTIVARIATE DISTRIBUTIONS

(71) Applicant: Google LLC, Mountain View, CA (US)

(72) Inventors: Michael Bendersky, Sunnyvale, CA (US); Hamed Zamani, Hadley, MA (US)

(21) Appl. No.: 18/641,257

(22) Filed: Apr. 19, 2024

Related U.S. Application Data
(60) Provisional application No. 63/460,599, filed on Apr. 19, 2023.

(51) Int. Cl. G06N 3/0455; G06N 3/084

(52) U.S. Cl. CPC G06N 3/0455; G06N 3/084

(57) ABSTRACT

Methods, systems, and apparatus, including computer programs encoded on computer storage media, for information retrieval using multivariate distributions. In particular, a system receives a query; processes the query using a query encoder neural network to generate parameters of a probability distribution over a space of multi-dimensional latent representations for the query; identifies, using the parameters of the probability distribution over the space of multivariate representations for the query, a subset of a plurality of content items; and generates a response to the query that identifies at least one of the content items in the subset.

### CROSS-REFERENCE TO RELATED APPLICATION

This application claims priority to U.S. Provisional Application No. 63/460,599, filed on Apr. 19, 2023. The disclosure of the prior application is considered part of and is incorporated by reference in the disclosure of this application.

### BACKGROUND

This specification relates to ranking content items using machine learning models.

As one example, neural networks are machine learning models that employ one or more layers of nonlinear units to predict an output for a received input. Some neural networks include one or more hidden layers in addition to an output layer. The output of each hidden layer is used as input to another layer in the network, e.g., the next hidden layer or the output layer. Each layer of the network generates an output from a received input in accordance with current values of a respective set of weights.

### SUMMARY

This specification describes a system implemented as computer programs on one or more computers that performs information retrieval using multivariate probability distributions.

In particular, the system uses the parameters of multivariate probability distributions to retrieve content items from a set of content items in response to received queries.

Particular embodiments of the subject matter described in this specification can be implemented so as to realize one or more of the following advantages.

Information retrieval systems that leverage latent representations generated by neural networks to rank content items in response to queries are referred to as dense retrieval models and have shown promising results on a variety of information retrieval tasks.

However, these dense retrieval models suffer from a major shortcoming: they do not represent the model's confidence in the learned representations generated by the neural network(s). That is, existing dense retrieval models represent each query and content item as a single point in a latent representation space that does not reflect any potential uncertainty in how the query or content item should be represented within the latent representation space.

This specification, on the other hand, describes techniques that explicitly model uncertainty (or confidence) in the learned query and document representations. In particular, the described techniques generate, for each query, parameters of a probability distribution over a space of multi-dimensional latent representations for the query.

Thus, the described techniques can model uncertainty (or confidence) in the learned query representation that is generated by the query encoder neural network.

Moreover, in addition to uncertainty, such probabilistic modeling can implicitly represent breadth of information in queries and content items.

For instance, a document that covers multiple topics and potentially satisfies a diverse set of information needs may be represented by a multivariate distribution with large variance values.

By using these multi-variate distributions and the resulting more robust representations, the system can more effectively perform information retrieval tasks than other systems. That is, the system can more effectively satisfy the informational need of users or external systems by more accurately retrieving the most relevant content items in response to a given query due to making use of the multi-variate distributions.

As a particular example, rather than determining relevance based on similarity sores between two points in the space, the system can determine relevance based on similarity scores that reflect the KL divergence between two probability distributions, i.e., a multi-variate distribution representing a query and a multi-variate distribution representing a content item. However, computing respective KL divergences for a large number of content items at query time can be computationally expensive and, in some cases, computationally prohibitive. Therefore, this specification describes techniques for efficiently computing similarity scores that approximate the KL divergence between two probability distributions, allowing the multi-variate probabilistic modeling techniques to be implemented using efficient search techniques, e.g., approximate nearest neighbor techniques. Thus, the described techniques can improve performance relative to conventional techniques without an increase in computational overhead.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example information retrieval system.

FIG. 1B shows an example of representations of two inputs.

FIG. 2 is a flow diagram of an example process for generating a response to a query.

FIG. 3 is a flow diagram of an example process for identifying a subset of content items.

FIG. 4 is a flow diagram of an example process for training the query encoder neural network.

FIG. 5 is an example of the performance of the described techniques.

Like reference numbers and designations in the various drawings indicate like elements.

### DETAILED DESCRIPTION

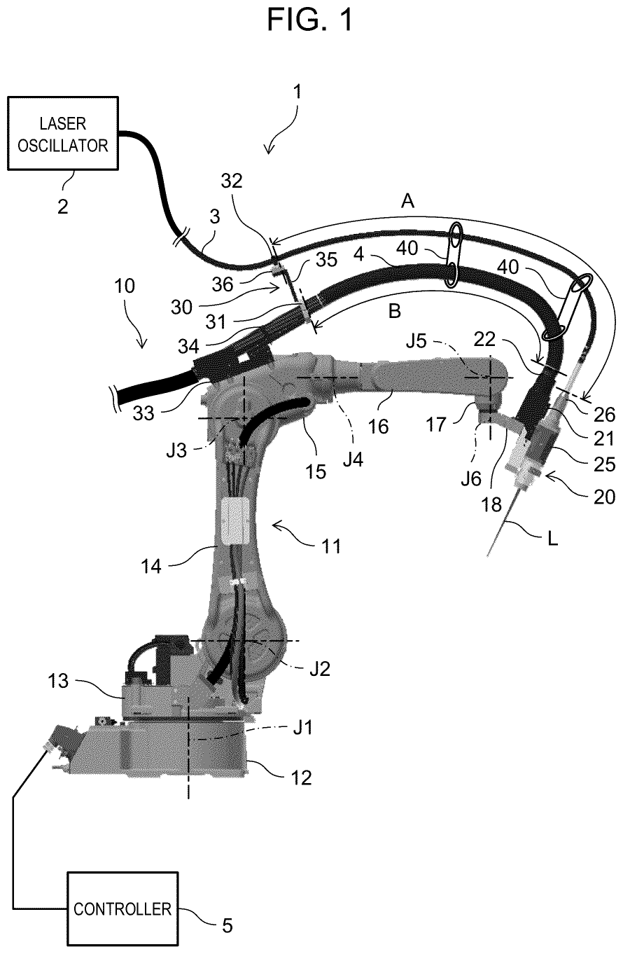

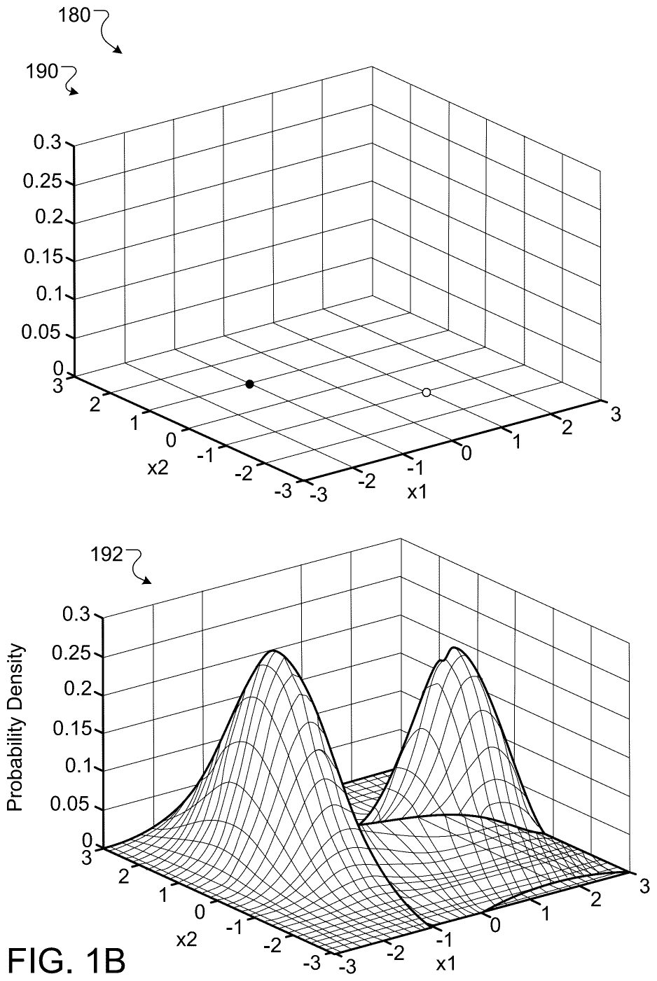

FIG. 1A shows an example information retrieval system 100. The information retrieval system 100 is an example of a system implemented as computer programs on one or more computers in one or more locations, in which the systems, components, and techniques described below can be implemented.

The system 100 is a system that performs information retrieval. That is, the system 100 retrieves content items from a set of content items 120 in response to received queries 110.

The content items in the set of content items 120 can be any appropriate electronic content. For example, the content items 120 can include any of text documents, individual text segments extracted from text documents, images, videos, web pages, audio data, multi-modal documents that include two different modalities of data, e.g., images and text, software applications, and so on.

In some cases, all of the content items in the set 120 are the same type of content item while in other implementations different content items in the set 120 are different types of content item.

As one example, the system 100 can be part of a search engine that searches a repository of content items in response to queries 110 received from users.

During operation, the system 100 receives a query 110. For example, the system 100 can receive a query 110 from a user device, e.g., a query 110 submitted to the system 100 by a user through the user device, over a data communication network, e.g., the Internet. As another example, the system 100 can receive the query 110 from another computer system, e.g., through an application programming interface (API) exposed by the system.

The query 110 can be, e.g., a natural language query, an image query, a multi-modal query, i.e., a query that includes multiple modalities of data, e.g., both text and images or both text and audio, or a query in a structured data format.

The system 100 then retrieves content items from the set of content items 120 in response to the received query 110 using parameters of multivariate probability distributions, e.g., using the parameters of a multivariate probability distribution that represents the received query 110 and respective parameters of respective multivariate probability distributions for the content items in the set of content items 120.

In particular, the system 100 processes the query 110 using a query encoder neural network 130 to generate parameters 132 of a probability distribution over a space of multi-dimensional latent representations for the query 110.

That is, unlike techniques that directly generate a latent representation using an encoder neural network, the system 100 generates parameters 132 of a multivariate probability distribution over the space of possible latent representations. Thus, the system 100 can model uncertainty (or confidence) in the learned query representation that is generated by the query encoder neural network 130.

Moreover, in addition to uncertainty, such probabilistic modeling can implicitly represent breadth of information in queries (and, as will be described below, content items).

For instance, a document that covers multiple topics and potentially satisfies a diverse set of information needs may be represented by a multivariate distribution with large variance values.

As another example, a query that is open-ended and may be satisfied by a diverse set of documents may also be represented by a distribution with large variance values.

This is shown visually in the example of FIG. 1B.

In particular, FIG. 1B shows an example 180 of representations of two different inputs, e.g., two queries, two content items, or a query and a content item.

FIG. 1B shows a first example 190 of representations used by conventional techniques. As can be seen from the example 190, conventional techniques map each input to a respective point in the space of latent representations. Thus, the only means of comparing the two inputs is by computing distances or similarities between the corresponding points in the space.

FIG. 1B also shows another example 192 of representations used by the described techniques. As can be seen from FIG. 1B, the same two inputs are represented by respective multi-variate distributions. This allows the system to effectively model uncertainty in representation learning. That means the model may produce a representation for a clear navigational query with high confidence (and therefore the distribution for the query can have low variance), while it may have lower confidence in representing an ambiguous query (and therefore the distribution for the query can have high variance). The same argument then applies for content items.

Returning to the description of FIG. 1A, a ranking engine 140 within the system 100 identifies, using the parameters 132 of the probability distribution over the space of multivariate representations for the query 110, a subset 122 of the set of content items 120, e.g., of the repository of content items that the system 100 is configured to search. Generally, the subset 122 is a proper subset that includes less than all of the content items in the repository.

In some implementations, the ranking engine 140 uses content vectors 124 for the content items in the set 120 to identify the subset 122, with the content vector 124 for each content item being generated from parameters of a probability distribution over the space of latent representations for the content item. Thus, the system 100 uses probabilistic modeling to represent uncertainty and breadth of information within both queries 110 and content items 120.

In these implementations, the ranking engine 140 can generally identify the subset 122 based on similarity measures between (i) a query vector for the query and generated from the parameters 132 and (ii) the content vectors 124.

In particular, as will be described below, the similarity measure between the query vector and a given content vector approximates the negative of the Kullback-Leibler (KL) divergence between (i) the probability distribution over the space of latent representations for the query and (ii) the probability distribution over the space of latent representations for the content item.

Thus, in these implementations, as part of identifying the subset 122 and as will be described below, the system 100 generates a similarity score, i.e., the value of the similarity measure, for each of the content items in set 120.

The system 100 then generates a response 150 to the query 110 that identifies at least one of the content items in the subset 122. For example, the system 100 can provide data identifying each of the content items in the subset 122, a further subset of content items that are most similar to the query 110 according to the similarity scores, or only the most similar content item according to the similarity scores.

As a particular example, the system 100 can generate search results that identify each content item in the subset 122 or the further subset, and then generate a response 150 that orders the search results according to a ranking of the corresponding content items by similarity score, e.g., with the most similar content item being first in the ranking.

The system 100 can then provide the response 150, e.g., as data to be presented in a user interface of the user device from which the query 110 was received or as data in a specified data interchange format to another computer system that submitted the query 110 to the system 100.

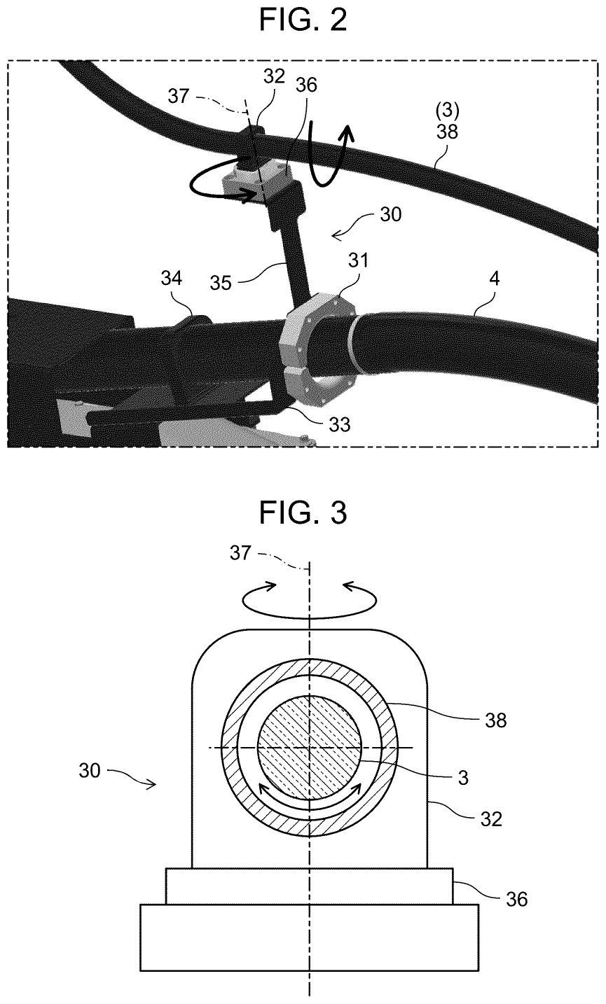

FIG. 2 is a flow diagram of an example process 200 for generating a response to a query. For convenience, the process 200 will be described as being performed by a system of one or more computers located in one or more locations. For example, an information retrieval system, e.g., the information retrieval system 100 of FIG. 1A, appropriately programmed, can perform the process 200.

The system receives a query (step 202).

The system processes the query using a query encoder neural network to generate parameters of a probability distribution over a space of multi-dimensional latent representations for the query (step 204).

Generally, each multi-dimensional latent representation in the space has a fixed number k of dimensions, where k is greater than one. In other words, each latent representation is a k-dimensional latent vector, i.e., a vector with k entries.

As one example, the probability distribution over the space can be a multi-variate normal distribution with a diagonal covariance matrix. As a result, the parameters of the distribution are (i) a respective mean for each of the k dimensions and (ii) a respective variance for each of the k dimensions.

To generate the parameters of the probability distribution, the system can process a sequence that includes tokens representing the query using the query encoder neural network.

The query encoder neural network can have any appropriate architecture that allows the query encoder neural network to map a sequence of tokens to the distribution parameters. As one example, the query encoder neural network can be an encoder-only self-attention neural network, i.e., a neural network that includes multiple self-attention layers that each update a set of input embeddings to the layer by applying a self-attention mechanism over the set of input embeddings.

As a particular example, the system can process a sequence that includes a first token, a second token, and a sequence of tokens representing the query using the query encoder neural network to generate a respective embedding of each of the tokens. For example, the first and second tokens can be two designated tokens from a vocabulary of tokens, one that represents the mean and one that represents the variance.

The system can then process the embedding of the first token, i.e., of the token that represents the mean, using a first output neural network head to generate the respective means for each of the k dimensions. For example, the first output neural network head can generate a k dimensional vector of the means for the dimensions. As one example, the first output neural network can be a dense projection layer.

The system also processes the embedding of the second token using a second output neural network head to generate the respective variances for each of the k dimensions. As one example, the first output neural network can be a dense projection layer followed by the softplus activation function.

Making use of the softplus activation function can be beneficial for a variety of reasons. For one, the softplus is continuous and differentiable, thus it can be used in gradient descent-based optimization, i.e., in training of the encoder neural network. As another, softplus ensures that variance values are always positive. As another, zero is the lower bound of the softplus yet it is never equal to zero, thus it does not cause numeric instability in KL-divergence calculations. As another, for large input values, softplus can be approximated using a linear function, ensuring numerical stability for large input values.

The system identifies, using the parameters of the probability distribution over the space of multivariate representations for the query, a subset of a plurality of content items (step 206), e.g., of the set of content items 120 described above with reference to FIG. 1A.

One example of identifying the subset of content items is described below with reference to FIG. 3.

The system generates a response to the query that identifies at least one of the content items in the subset (step 208). For example, the system can generate the response as described above with reference to FIG. 1A.

FIG. 3 is a flow diagram of an example process 300 for identifying a subset of content items using the parameters of the probability distribution over the space of multivariate representations for the query. For convenience, the process 300 will be described as being performed by a system of one or more computers located in one or more locations. For example, an information retrieval system, e.g., the information retrieval system 100 of FIG. 1A, appropriately programmed, can perform the process 300.

The system maintains, for each of the plurality of content items, a respective content vector (step 302).

Generally, the content vector for any given content item is generated from the parameters of a probability distribution over the space of multi-dimensional latent representations for the given content item.

In particular, to generate the content vector for any given content item, the system processes the content item using a content item encoder neural network to generate the parameters of a probability distribution over the space of multi-dimensional latent representations for the content item.

For example, to generate the parameters, the system can process a sequence that includes the first token, the second token, and tokens representing the content item using the content item encoder neural network to generate a respective embedding of each of the tokens.

The system can then process the embedding of the first token using one output neural network head to generate the respective means for each of the k dimensions and process the embedding of the second token using another output neural network head to generate the respective variances for each of the k dimensions. The first and second output neural network heads can have the same architecture described above for the corresponding heads of the query encoder neural network.

In some implementations, e.g., when the content items and the queries are of the same content item type, the content item encoder neural network can be the same neural network as the query encoder neural network. In some other implementations, e.g., when the content items and the queries are of different content item types, the content item encoder neural network can be a different neural network from the query encoder neural network.

The system then generates the content vector for the content item from the parameters of the probability distribution over the space of multi-dimensional latent representations for the content item. Generally, each entry in the content vector depends on the means for the dimensions, the covariances for the dimensions, or both.

As a particular example, the content vector can be represented as:

$$\vec{d} = [ {γ}_{d} \frac{- 1}{{\prod }_{d}} , \frac{- 1}{{σ}_{d 1}^{2}} , \frac{- 1}{{σ}_{d 2}^{2}} , … , \frac{- 1}{{σ}_{dk}^{2}} , \frac{2 {μ}_{d 1}}{{σ}_{d 1}^{2}} , \frac{2 {μ}_{d 2}}{{σ}_{d 2}^{2}} , … , \frac{2 {μ}_{dk}}{{σ}_{dk}^{2}} ] ,$$

where γ_{d} is a query-independent document prior score, e.g.,

$${γ}_{d} = - {\sum }_{i = 1}^{k} ( log {σ}_{di}^{2} + \frac{{μ}_{di}^{2}}{{σ}_{di}^{2}} ) ,$$

$${\prod }_{d} = {\prod }_{i = 1}^{k} {σ}_{di}^{2} ,$$

μ_{di} is the mean for dimension i for the content item, and σ_{di}² is the variance for dimension i for the content item.

The system generates, using the parameters of the probability distribution over the space of multivariate representations for the query, a query vector (step 304).

Generally, some or all of the entries in the query vector depend on the means for the dimensions of probability distribution for the query, the covariances for the dimensions for the query, or both.

As a particular example, the query vector can be represented as:

$$\vec{q} = [ 1 , {\prod }_{q} , {σ}_{q 1}^{2} , {σ}_{q 2}^{2} , … , {σ}_{qk}^{2} , {μ}_{q 1} , {μ}_{q 2} , … , {μ}_{q k} ] ,$$

where, π_{q} =πᵢ₌₁^{k} σ_{qi}², μ_{qi} is the mean for dimension i for the query, and σ_{qi}² is the variance for dimension i for the query.

Advantageously, the system can pre-compute the content vectors once the content item encoder neural network has been trained and store the content vectors as representations of the content items in a data structure that allows the content vectors to be efficiently searched, e.g., in an index database.

The system identifies the subset of the plurality of content items using the content vectors and the query vector (step 306).

For example, the system can search the plurality of content items using a search technique that outputs a subset of content items that have content vectors that are most similar to the query vector according to a similarity measure.

The system can generally use any appropriate similarity measure to perform the search. For example, the similarity measure can be the dot product between two vectors. As another example, the similarity measure can be the Euclidean distance between two vectors.

The system can generally use any appropriate search technique for searching the content vectors. As a particular example, the search technique can be an approximate nearest neighbor technique.

Because of the way that the system generates the query vector and the content vectors, for each content item, the similarity measure between the query vector and the content vector for the content item approximates the negative of the KL divergence between (i) the probability distribution over the space of multi-dimensional latent representations defined by the parameters generated for the query and (ii) the probability distribution over the space of multi-dimensional latent representations defined by the parameters generated for the content item.

However, because the similarity scores are computed as vector operations, e.g., dot products between vectors, rather than as KL divergences between probability distributions, the similarity scores can be computed in a computationally efficient manner as part of the search technique.

In order to efficiently perform the process 300, the system can maintain the content vectors by indexing the respective content vectors in an index database and then search the content items using the search technique by searching the indexed content vectors in the index database using the search technique. This allows the system to perform efficient retrieval for any given query vector (and, as a result, any given query) even when the number of content items in the set is large.

Prior to using the query encoder neural network and, when the two neural networks are different, the content item encoder neural network to perform information retrieval, the system or another training system trains the query encoder neural network and, when the two neural networks are different, the content item encoder neural network on a set of training data.

The set of training data generally includes a set of training queries and, for each training query, a set of training content items.

The training system can generally train the neural network(s) on the training data using any of a variety of learning to rank loss functions, where the scoring function for the learning to rank training is the similarity scores between query vectors and content vectors as described above or the negative KL divergence between the corresponding probability distributions.

As one example, the training system can train the query encoder neural network and, when the two neural networks are different, through distillation from a pre-trained teacher neural network.

One example of this distillation training is described below with reference to FIG. 4.

FIG. 4 is a flow diagram of an example process 400 for performing a training step during the training of the query encoder neural network. For convenience, the process 400 will be described as being performed by a system of one or more computers located in one or more locations. For example, an information retrieval system, e.g., the information retrieval system 100 of FIG. 1A, appropriately programmed, can perform the process 400.

The system receives a batch of training examples (step 402). Each training example includes a training query and a set of training content items for the training query.

For example, the training content items can include a set of positive content items that have been determined to be relevant to the training query and a set of negative content items that have been determined to not be relevant to the training query. As one example, the negative content items can be the positive content items within the other training examples in the batch.

For each training example, the system generates a respective student score for each training content item in the training example using the query encoder neural network, e.g., as described above (step 404).

For each training example, the system generates a respective teacher score for each training content item in the training example using the pre-trained teacher neural network (step 406). For example, the teacher score can be a dot product between an embedding of the query and an embedding of the content item as generated by the pre-trained teacher neural network.

The system then determines a gradient with respect to the parameters of the query encoder neural network of a distillation loss function (step 408).

Generally, the distillation loss function measures, for each training example, differences between a ranking of the training content items in the training example generated using the student scores and a ranking of the content items generated using the teacher scores.

As one example, the distillation loss for a training example that includes a query q and a set of training content items D_{q} can be expressed as:

$${\sum }_{d , {d}^{′} ∈ {D}_{q}} 𝕀 \{ {y}_{q}^{T} ( d ) > {y}_{q}^{T} ( {d}^{′} ) \} \vert \frac{1}{{π}_{q} ( d )} - \frac{1}{{π}_{q} ( {d}^{′} )} \vert log ( 1 + {e}^{{y}_{q}^{S} ( {d}^{′} ) - {y}_{q}^{S} ( d )} ) ,$$

where d and d′ are content items in D_{q}, [symbol] is the indicator function, y_{q}^{T}(d) is the teacher score for content item d, y_{q}^{s}(d) is the student score for content item d, and π_{q}(d) denotes the rank of content item d in a result list produced according to the student scores for the content items.

The system then trains the query encoder neural network using the gradient (step 410).

For example, the system can apply an optimizer to the gradient to update the values of the parameters of the query encoder neural network. When there is a separate content item encoder, the system can incorporate a pre-trained teacher content item decoder into the training, i.e., to generate the teacher scores, and then train the content item encoder jointly with the query encoder neural network on the above loss function.

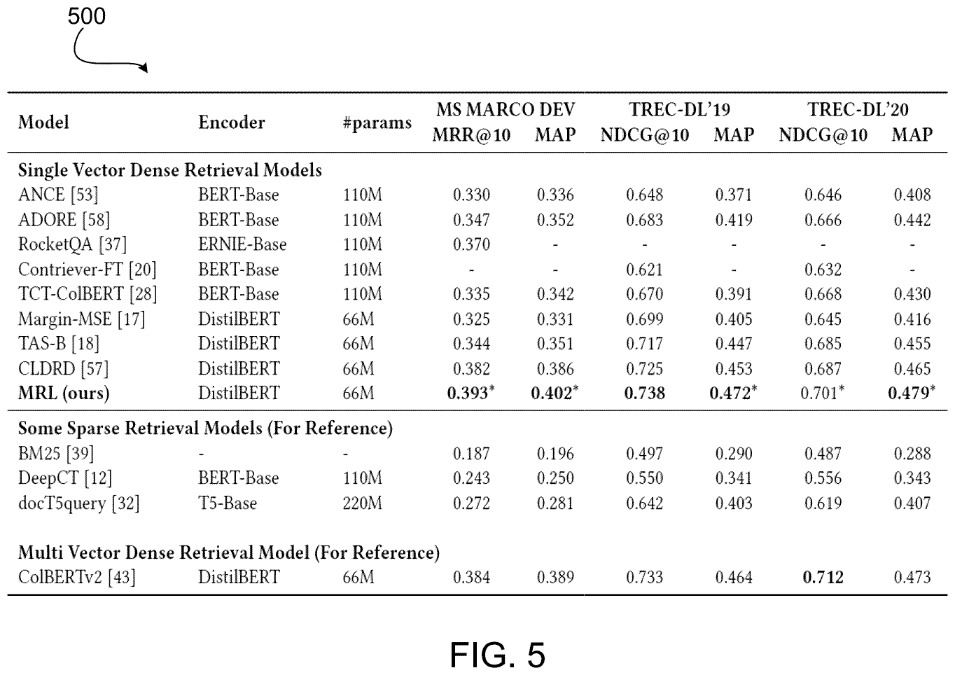

FIG. 5 shows an example 500 of the performance of the described techniques (“MRL (ours)”) relative to a variety of existing dense and sparse retrieval models that do not use multi-variate representations.

As can be seen from the example 500, the described techniques outperform the existing techniques on three different data sets and on multiple metrics.

Moreover, example 500 shows the performance of a technique that uses multiple different vectors to represent each query and content item (“ColBERTv2”). Despite the fact that the described techniques use a single vector and are therefore much more computationally efficient, the described techniques achieve performance that is comparable to that of ColBERTv2 on all of the three tasks and, for some tasks and some metrics, achieve performance that exceeds that of the ColBERTv2 technique.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving a query;
processing the query using a query encoder neural network to generate parameters of a probability distribution over a space of multi-dimensional latent representations for the query;
identifying, using the parameters of the probability distribution over the space of multivariate representations for the query, a subset of a plurality of content items; and
generating a response to the query that identifies at least one of the content items in the subset.

2. The method of claim 1, wherein each multi-dimensional latent representation in the space has a fixed number k of dimensions, wherein k is greater than one.

3. The method of claim 2, wherein the probability distribution over the space is a multi-variate normal distribution with a diagonal covariance matrix and wherein the parameters comprise a respective mean for each of the k dimensions and a respective variance for each of the k dimensions.

4. The method of claim 3, wherein processing the query using a query encoder neural network to generate parameters of a probability distribution over a space of multi-dimensional latent representations for the query comprises:
processing a sequence that includes a first token, a second token, and a plurality of tokens representing the query using the query encoder neural network to generate a respective embedding of each of the tokens;
processing the embedding of the first token using a first output neural network head to generate the respective means for each of the k dimensions; and
processing the embedding of the second token using a second output neural network head to generate the respective variances for each of the k dimensions.

5. The method of claim 1, further comprising:
maintaining, for each of the plurality of content items, a respective content vector, and wherein identifying, using the parameters of the probability distribution over the space of multivariate representations for the query, a subset of a plurality of content items comprises:
generating, from the parameters of the probability distribution, a query vector for the query; and
identifying the subset of the plurality of content items using the content vectors and the query vector.

6. The method of claim 5, wherein identifying the subset of the plurality of content items using the content vectors and the query vector comprises:
searching the plurality of content items using a search technique that outputs a subset of content items that have content vectors that are most similar to the query vector according to a similarity measure.

7. The method of claim 6, wherein the similarity measure is a dot product.

8. The method of claim 6, wherein the search technique is an approximate nearest neighbor technique.

9. The method of claim 6, further comprising:
generating the respective content vectors for each of the content items, comprising, for each content item:
processing the content item using a content item encoder neural network to generate parameters of a probability distribution over the space of multi-dimensional latent representations for the content item; and
generating the content vector for the content item from the parameters of a probability distribution over the space of multi-dimensional latent representations for the content item.

10. The method of claim 9, wherein each multi-dimensional latent representation in the space has a fixed number k of dimensions, wherein k is greater than one, wherein the probability distribution over the space is a multi-variate normal distribution with a diagonal covariance matrix, wherein the parameters comprise a respective mean for each of the k dimensions and a respective variance for each of the k dimensions, and wherein processing the content item using a content item encoder neural network to generate parameters of a probability distribution over the space of multi-dimensional latent representations for the content item comprises:
processing a sequence that includes a first token, a second token, and a plurality of tokens representing the content item using the content item encoder neural network to generate a respective embedding of each of the tokens;
processing the embedding of the first token using a first output neural network head to generate the respective means for each of the k dimensions; and
processing the embedding of the second token using a second output neural network head to generate the respective variances for each of the k dimensions.

11. The method of claim 9, wherein the query and content item encoder neural networks are the same neural network.

12. The method of claim 9, wherein, for each content item, the similarity measure between the query vector and the content vector for the content item approximates a negative KL divergence between (i) the probability distribution over the space of multi-dimensional latent representations defined by the parameters generated for the query and (ii) the probability distribution over the space of multi-dimensional latent representations defined by the parameters generated for the content item.

13. The method of claim 1, wherein the query encoder neural network is an encoder-only self-attention neural network.

14. The method of claim 1, wherein the query encoder neural network has been trained through distillation from a pre-trained teacher neural network.

15. The method of claim 6, wherein the similarity measure generates a respective similarity score for each of the content items in the subset, and wherein generating a response to the query that identifies at least one of the content items in the subset comprises:
ranking the subset of content items according to the respective similarity scores for the content items in the subset.

16. The method of claim 15, wherein generating the response comprises:
generating a respective search result that identifies each of the one or more content items; and
ordering the respective search results according to the respective similarity scores for the content items.

17. The method of claim 1, wherein receiving a query comprises receiving the query from a user device, and wherein the method further comprises:
providing the response for presentation on the user device.

18. The method of claim 6, wherein maintaining, for each of the plurality of content items, a respective content vector comprises indexing the respective content vectors in an index database; and wherein searching the plurality of content items using the search technique comprises searching the indexed content vectors in the index database using the search technique.

19. A system comprising:
one or more computers; and
one or more storage devices storing instructions that, when executed by the one or more computers, cause the one or more computers to perform operations comprising:
receiving a query;
processing the query using a query encoder neural network to generate parameters of a probability distribution over a space of multi-dimensional latent representations for the query;
identifying, using the parameters of the probability distribution over the space of multivariate representations for the query, a subset of a plurality of content items; and
generating a response to the query that identifies at least one of the content items in the subset.

20. One or more non-transitory computer-readable storage media storing instructions that when executed by one or more computers cause the one or more computers to perform operations comprising:
receiving a query;
processing the query using a query encoder neural network to generate parameters of a probability distribution over a space of multi-dimensional latent representations for the query;
identifying, using the parameters of the probability distribution over the space of multivariate representations for the query, a subset of a plurality of content items; and
generating a response to the query that identifies at least one of the content items in the subset.
